(19) United States
(12) Patent Application Publication
(10) Pub. No.: US 2013/0115463 A1
(43) Pub. Date: May 9, 2013

(54) PEARL PACKING STRUCTURE

(71) Applicant: Chien-Chiang Chiu, Taichung City (TW)

(72) Inventor: Chien-Chiang Chiu, Taichung City (TW)

(21) Appl. No.: 13/338,466

(22) Filed: Dec. 28, 2011

(30) Foreign Application Priority Data
Nov. 4, 2011 (TW) 100220852

(51) Int. Cl. B32B 5/16

(52) U.S. Cl. 428/403

(57) ABSTRACT

A pearl packing structure is provided, which is used to pack at least a pearl. A predefined three-dimensional soap body is formed from saponified soap material, and said pearl is covered into a fixed position of the soap body, so the pearl is enclosed by the soap body. Hence, it is possible to realize the concept of environmental protection and improve the added value of the pearl while applying the soap body to keep the body clean more easily.

### CROSS-REFERENCE TO RELATED U.S. APPLICATIONS

Not applicable.

### STATEMENT REGARDING FEDERALLY SPONSORED RESEARCH OR DEVELOPMENT

### Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates generally to a pearl packing structure, and more particularly to an innovative one which is designed with a soap body for covering the pearl.

2. Description of Related Art Including Information Disclosed Under 37 CFR 1.97 and 37 CFR 1.98.

Pearl decorations are highly enjoyed by the female since they mirror the nobleness and elegancy from its natural luster. Further, the pearl can be milled into pearl powder, which is applied facially or taken orally for health care and beauty treatment. However, the natural pearl is often formed after a long period of time, so most of pearl products are shaped by artificial breeding, leading to quality differences arising from the breeding environment and mode.

However, either the pearl powder or the pearl decorations must be packed by cases or bags before sales. Since the consumers only use the products therein, the cases or bags are often discarded, causing waste against environmental protection and lack of added value.

Thus, to overcome the aforementioned problems of the prior art, it would be an advancement if the art to provide an improved structure that can significantly improve the efficacy.

Therefore, the inventor has provided the present invention of practicability after deliberate design and evaluation based on years of experience in the production, development and design of related products.

### BRIEF SUMMARY OF THE INVENTION

Based on the pearl packing structure of the present invention wherein a predefined 3D soap body is formed from saponified soap material, said pearl is covered into a fixed position of the soap body and enclosed by the soap body. The present invention is superior to the prior art where the pearl must be packed simply by cases or bags, and the consumers only use the products therein, so the cases or bags are often discarded, causing waste against environmental protection and lack of added value. If the pearl is packed by the soap body of the present invention, it is possible to realize the concept of environmental protection and improve the added value of the pearl while applying the soap body to keep our body clean more easily.

The improvements brought about by this invention are as follow:

Soluble pearl powder could be added into the soap body, so as to make it exude pearly luster, increase its aesthetic perception and value while improving the effect of skin whitening and skin care.

Although the invention has been explained in relation to its preferred embodiment, it is to be understood that many other possible modifications and variations can be made without departing from the spirit and scope of the invention as hereinafter claimed.

### BRIEF DESCRIPTION OF THE SEVERAL VIEWS OF THE DRAWINGS

FIG. 1 is a schematic view of a preferred embodiment of the pearl packing structure of the present invention.

FIG. 2 is a schematic view of another preferred embodiment of the pearl packing structure of the present invention.

FIG. 3 is a sectional view of FIG. 2.

### DETAILED DESCRIPTION OF THE INVENTION

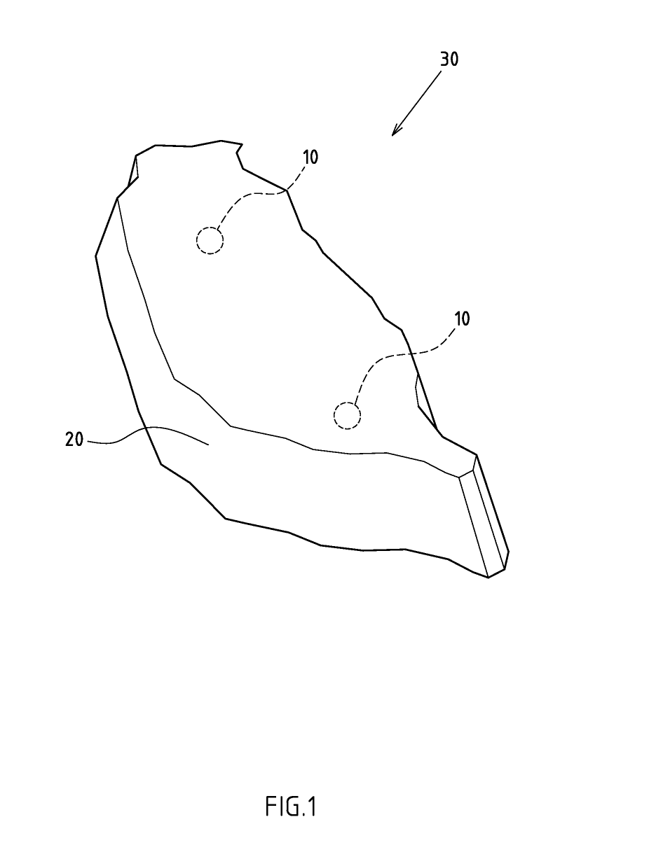

FIGS. 1-3 depict preferred embodiments of the pearl packing structure of the present invention, which, however, are provided for only explanatory objective for patent claims. Said pearl packing structure is used to pack at least a pearl 10. A predefined 3D soap body 30 is formed from saponified soap material 20, and said pearl 10 is covered into a fixed position of the soap body 30, so the pearl 10 is enclosed by the soap body 30.

Of which, the soap body 30 is transparent or semi-transparent, enabling clear viewing of the pearl 10 covered into the soap body 30.

Of which, essential oil and Hinoki essential, etc, can be added into the soap body 30, making it exude special aroma, or natural materials useful to skin, such as: natural plant essential oil and lecithin, etc, are used to increase the added value of the soap body 30.

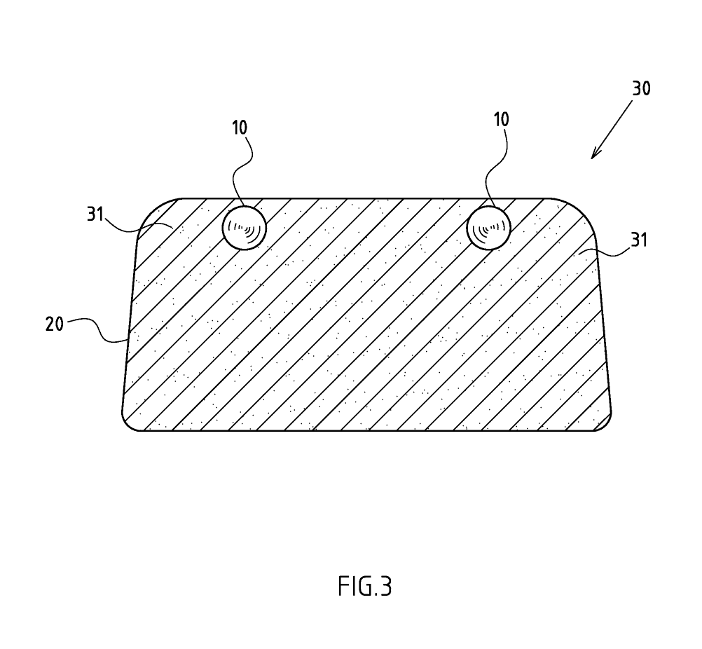

Referring to FIG. 3, soluble pearl powder 31 could be added into the soap body 30 so as to make it exude pearly luster, increase its aesthetic perception and value while improving the effect of skin whitening and skin care.

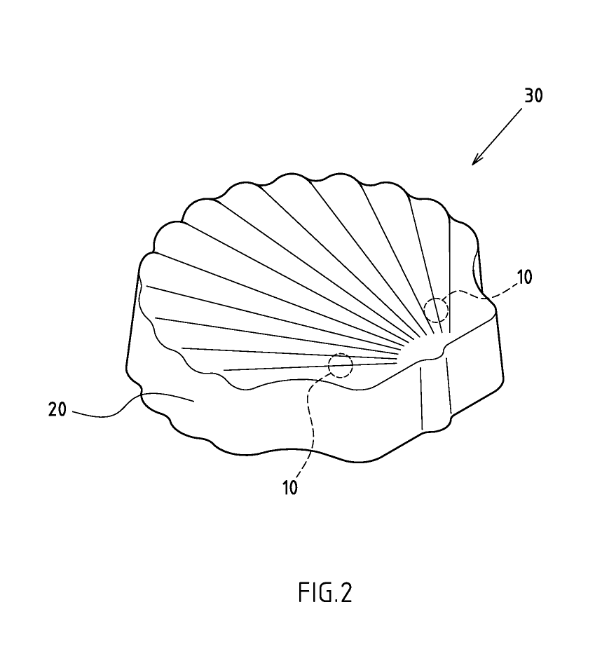

Of which, the soap body 30 is configured into either of blocky, laminar, mimic and irregular shapes. Referring to FIG. 1, the soap body 30 is of an elongated oval shape (resembling Taiwan). Or, referring to FIG. 2, the soap body 30 is of a shell-like shape.

Additionally, a layer of transparent plastic film could be covered onto the soap body 30, such that the soap body 30 could not get into contact with other articles prior to use. Moreover, the component of the soap body 30 could not cause damage to the covered pearl 10. That means that the pearl 10 packaged in the soap body 30 could be protected by the soap body 30, and also taken out to be processed into decorations such as necklaces, earrings and jewelry.

I claim:

1. A pearl packing structure, which comprising:
a soap body, which is of a predefined 3D shape formed from saponified soap material;
at least a pearl, which is covered into a fixed position of the soap body;
thus, said pearl is enclosed by the soap body.

2. The structure defined in claim 1, wherein essential oil and Hinoki essential, etc, can be added into the soap body, making it exude special aroma.

3. The structure defined in claim 1 or 2, wherein soluble pearl powder could be added into the soap body so as to make it exude pearly luster while improving the effect of skin whitening and skin care.

4. The structure defined in claim 1, wherein the soap body is designed into either of blocky, laminar, mimic and irregular shapes.

5. The structure defined in claim 1, wherein the component of the soap body could not cause damage to the covered pearl; moreover, the pearl packaged in the soap body could be protected by the soap body, and also taken out to be processed into decorations such as: necklaces, earrings and jewelries.
